(19) United States
(12) Patent Application Publication
(10) Pub. No.: US 2004/0261288 A1
(43) Pub. Date: Dec. 30, 2004

(54) Clothes dryer drum projections

(76) Inventors: Michael Thomas Beyerle, Pewee Valley, KY (US); David Duane Warmuth, Louisville, KY (US)

Correspondence Address: John S. Beulick, Armstrong Teasdale LLP, Suite 2600, One Metropolitan Square, St. Louis, MO, 63102, US

(21) Appl. No.: 10/610,014

(22) Filed: Jun. 30, 2003

(51) Int. Cl. F26B 11/02

(52) U.S. Cl. 34/602

(57) ABSTRACT

A plurality of dryer bumps for a dryer drum, wherein each bump includes a contact portion that is configured to be positioned within the drum proximate another bump contact portion, an outer portion that is configured to be positioned adjacent to the drum, and a body extending between the contact portion and the outer portion.

### BACKGROUND OF THE INVENTION

This invention relates generally to clothes drying systems, and, more particularly, to tumbling aids for clothes dryers.

An appliance for drying articles such as a clothes dryer for drying clothing articles typically includes an exterior cabinet and internal rotating drum for tumbling clothes and laundry articles therein. One or more heating elements heats air prior to air entering the drum, and the warm air is circulated through the dryer as the clothes are tumbled to remove moisture from the laundry articles contained in the drum.

Some known clothes dryers utilize an extended surface on the interior of the drum, called a baffle to facilitate the tumbling of the clothes. Typically the baffles are mounted on the inside surface of the drying drum to lift the clothes into the warm air stream and to tumble the clothes towards the approximate rotational center of the drum. The shapes and sizes of baffles vary greatly but in general have uniform height that extends across the depth of the cylindrical drum. Other known baffles have varying heights across the depth of the drum and may be curved to better lift the clothes to as they tumble within the drum.

Known baffle designs may reduce the usable capacity in the drum, which, in turn, may increase the number of loads of laundry required by the operator and may restrict the air flow within the drum increasing the time to dry the clothes contained within the drum. Increasing the usable capacity of the dryer drum allows the operator to add additional laundry, reduce the number of drying operations, dry the clothes faster, and conserve energy.

### BRIEF DESCRIPTION OF THE INVENTION

In one aspect, plurality of dryer bumps are provided that include a contact portion that is configured to be positioned within the drum proximate another bump contact portion, an outer portion that is configured to be positioned adjacent to the drum, and a body extending between the contact portion and the outer portion.

In another aspect, a dryer drum for a clothes dryer is provided that includes a perforated back wall and a cylindrical outer wall adjacent to the back wall, wherein the outer wall includes an inner surface, an exterior surface, and a body extending therebetween and at least one dryer bump attached to the outer wall.

In another aspect, a clothes dryer is provided that includes a cabinet, a rotatable drum mounted in the cabinet, wherein the drum is configured to secure at least one laundry article against an inner surface of the drum during dryer operation, the drum is further configured to allow substantially unobstructed access to the drum. The dryer further includes at least one dryer bump protruding in to the drum, a motor for rotating the drum, an air circulation system, a heater for warming air circulated by the air circulation system, and a controller that is operatively coupled to the motor, the air circulation system temperature, and the heater.

### BRIEF DESCRIPTION OF THE DRAWINGS

FIG. 1 is partial perspective view of an exemplary dryer appliance.

FIG. 2 is perspective view of an exemplary dryer drum shown in FIG. 1.

FIG. 3 is a partial side view of the dryer drum shown in FIG. 2.

FIG. 4 is a perspective view of an alternative embodiment of the dryer drum bump shown in FIG. 3.

FIG. 5 is a partial side view of another alternative embodiment of dryer drum and dryer bumps shown in FIG. 3.

FIG. 6 is a perspective view of another alternative embodiment of the dryer drum bump shown in FIG. 3.

### DETAILED DESCRIPTION OF THE INVENTION

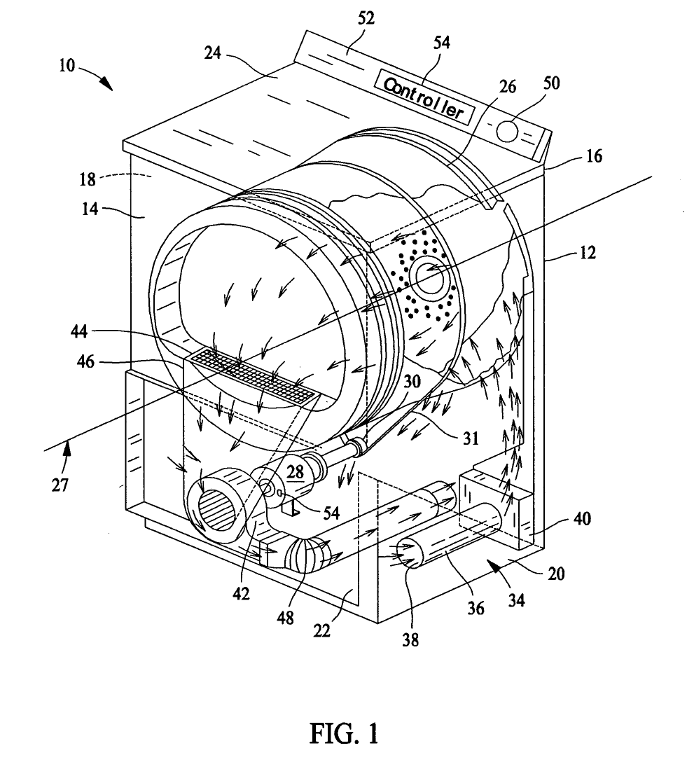

FIG. 1 is an exemplary clothes dryer appliance 10 in which the present invention may be practiced. While described in the context of a specific embodiment of dryer 10, it is recognized that the benefits of the invention may accrue to other types and embodiments of dryer appliances. Therefore, the following description is set forth for illustrative purposes only, and the invention is not intended to be limited in practice to a specific embodiment of dryer appliance, such as dryer 10.

Clothes dryer 10 includes a cabinet or a main housing 12 having a front panel 14, a rear panel 16, a pair of side panels 18 and 20 spaced apart from each other by the front and rear panels, a bottom panel 22, and a top cover 24. Within cabinet 12 is a drum or container 26, described in greater detail below, mounted for rotation around a substantially horizontal axis 27. A motor 28 rotates drum 26 about horizontal axis 27 through a pulley 30 and a belt 31. Drum 26 is supported within main housing 12 by a suitable fixed bearing (not shown) and is configured to receive hot air that has been heated by a heater 34 such as a combustion chamber 36 and a rear duct 38. The combustion chamber 36 receives ambient air via an inlet 40.

Although the clothes dryer 10 is illustrated in FIG. 1 as a gas dryer, in one embodiment dryer 10 is an electric dryer without combustion chamber 36 and rear duct 38. The heated air is drawn from drum 26 by a blower fan 42 which is also driven by motor 28. The air passes through a screen filter 44 which traps any lint particles. As the air passes through screen filter 44, the air enters a trap duct seal 46 and is passed out of clothes dryer 10 through an exhaust duct 48. A cycle selector knob 50 is mounted on a cabinet backsplash 52 and is in communication with a controller 54. Signals generated in controller 54 operate motor 28 and heater 34 in response to a position of selector knob 50.

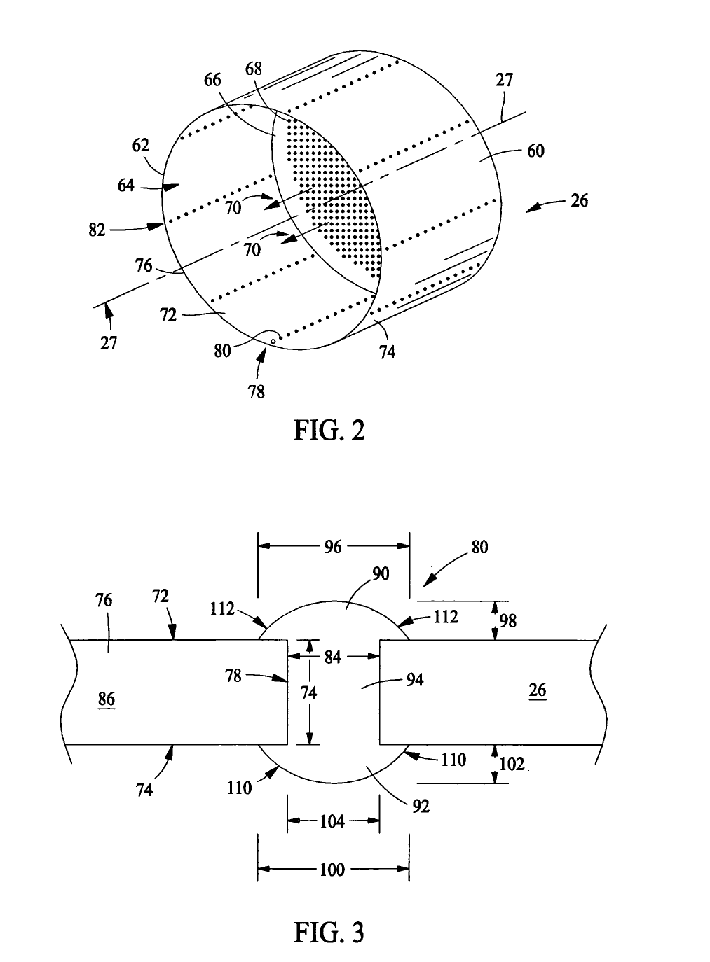

FIG. 2 is perspective view of dryer drum 26 (shown in FIG. 1). Drum 26 is generally cylindrical in shape, having an outer cylindrical wall 60 and a front flange or wall 62 defining an opening 64 therein to accommodate loading and unloading drum 26 with articles of clothing. In one embodiment, outer wall 60 is attached to a rear wall 66 that includes a plurality of holes 68 for receiving hot air 70 from heater 34 (shown in FIG. 1). In an alternative embodiment, outer wall 60 is not attached to rear wall 66 and rotates independently of rear wall 66.

Outer wall 60 has an inner surface 72, an outer surface 74, and a body 76 that extends therebetween. In one embodiment, a plurality of apertures 78, described in greater detail below, are disposed in outer wall 60 wherein each aperture 78 is configured to receive a dryer bump 80, described in greater detail below, therein. Each aperture 78 is equally spaced, and arranged in a plurality of rows 82. Each row 82 is parallel to the horizontal axis 27 and equally spaced circumferentially about outer wall 60.

The illustrative embodiment includes eight rows 82 as it is a relatively large capacity dryer. Smaller dryers may include less than eight rows 82. It is anticipated that any plurality of rows 82 may be employed in dryer 10. For example, in illustrative embodiments, three, six, or nine rows 82 are employed in a drum, although even greater numbers of rows 82 may be employed. As such, the embodiments shown in FIGS. 1 and 2 are provided for illustrative purposes only, and in no way is intended to be restricted to practice in any particular number of rows or in any particular location in a dryer.

FIG. 3 is a partial side view of dryer drum aperture 78 and dryer bump 80. Each aperture 78 has a diameter 84 variably sized to accommodate each dryer bump 80. In one embodiment, diameter 84 is 0.40 inches. In another embodiment, diameter 84 is approximately between 0.30 inches and 0.50 inches. In yet another embodiment, diameter 84 is approximately between 0.20 inches and 0.60 inches.

Each dryer bump 80 includes a contact portion 90, an attachment portion 92, and a body 94 that extends therebetween. Contact portion 90 includes a diameter 96 variably sized to drum 26 and a height 98 measured from drum inner surface 72. Contact portion diameter 96 is greater than aperture diameter 84. In one embodiment, diameter 96 is 0.45 inches and height 98 is 0.23 inches. In another embodiment, diameter 96 is approximately between 0.40 inches and 0.50 inches and height 98 is approximately between 0.18 inches and 0.28 inches. In yet another embodiment, diameter 96 is approximately between 0.25 inches and 0.65 inches and height 98 is approximately between 0.10 inches and 0.50 inches.

Contact portion 90 may have a variety of shapes that facilitate securing clothing articles against drum interior surface 72. In the exemplary embodiment, contact portion 90 is hemispherical-shaped. In another embodiment, contact portion 90 is convex-shaped. In an alternate embodiment, contact portion 90 is cylindrical-shaped.

Attachment portion 92 includes a diameter 100 variably sized to aperture 78 and a height 102 measured from drum exterior surface 74. Attachment portion diameter 100 is greater than aperture diameter 84. In one embodiment, diameter 100 is 0.45 inches and height 102 is 0.23 inches. In another embodiment, diameter 100 is approximately between 0.40 inches and 0.50 inches and height 102 is approximately between 0.18 inches and 0.28 inches. In yet another embodiment, diameter 100 is approximately between 0.25 inches and 0.65 inches and height 102 is approximately between 0.10 inches and 0.50 inches.

Attachment portion 92 may have a variety of shapes that facilitate securing bump 80 against drum interior surface 72. In the exemplary embodiment, attachment portion 92 is hemispherical-shaped. In another embodiment, contact portion 90 is conical-shaped.

Body 94 includes a diameter 104 and a height 106 measured from contact portion 90 to attachment portion 92. In one embodiment, body diameter 104 is substantially equal to aperture diameter 84. In one embodiment, diameter 104 is 0.40 inches and height 106 is 0.018 inches. In another embodiment, diameter 104 is approximately between 0.30 inches and 0.50 inches and height 106 is approximately between 0.017 inches and 0.019 inches. In yet another embodiment, diameter 104 is approximately between 0.20 inches and 0.60 inches and height 106 is approximately between 0.015 inches and 0.021 inches.

In one embodiment, bump 80 is manufactured from an elastomer such as vulcanized rubber, silicone rubber, and natural rubber. In an alternative embodiment, bump 80 is manufactured from a high-impact, heat-resistant, and resilient material. In one embodiment, bump 80 is unitary and solid. In an alternative embodiment, bump 80 is non-unitary and hollow.

Bumps 80 may be secured to drum 26 by hand, by machine, or by any means appropriate. In one embodiment, attachment portion 92 includes an attachment lip 110 that extends about the circumference of portion 92. Lip 110 is configured to pass through aperture 78 and seat adjacent drum outer surface 74. Contact portion 90 includes an attachment lip 112 that extends about the circumference of portion 90. Lip 112 is configured to seat adjacent drum inner surface 72 after lip 110 is seated. Body 94 is configured to seat adjacent drum aperture 78 and create an air tight seal such that bumps 80 facilitate preventing air passage in or out of drum 26.

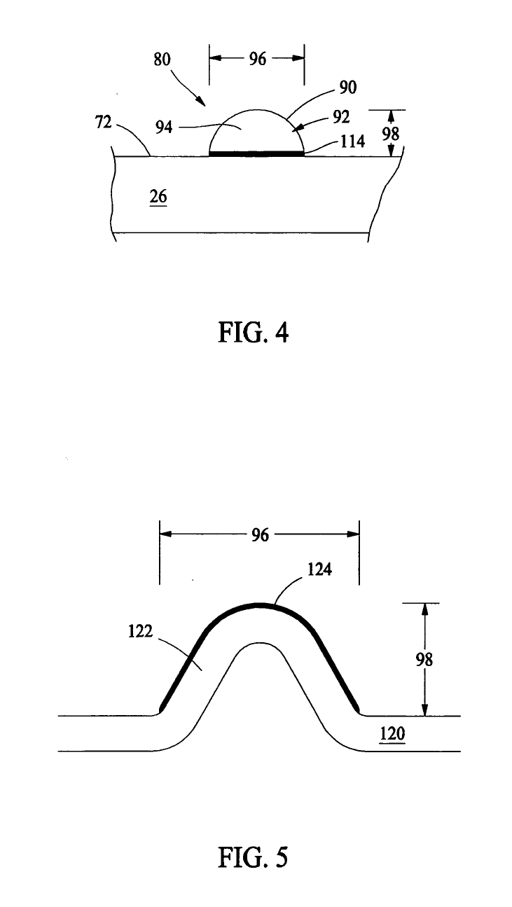

FIG. 4 is a partial side view of an alternative embodiment of dryer bump 80 shown in FIG. 3. Attachment portion 92 is configured to be coupled to drum inner surface 72 using a chemical fastener 114, including, but not limited to, an adhesive or a glue. In one embodiment, attachment portion 92 is substantially flat.

FIG. 5 is a perspective view of an alternative embodiment of dryer drum 26 and dryer bumps 80 shown in FIG. 3. A drum 120 is cast such that a plurality of bumps 122 are stamped into rows as described above. Bumps 122 are coated with rubber or a rubber-like material 124. Bumps 122 are shaped and sized similar to bumps 80. Rubber material 124 is fabricated from a rubber material similar to bump 80.

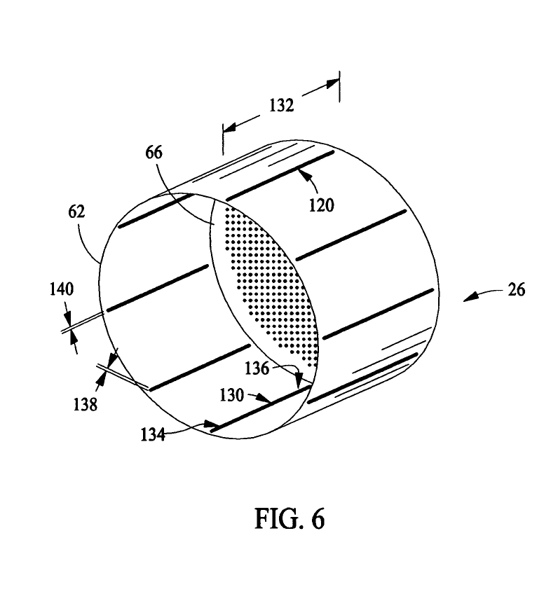

FIG. 6 is a perspective view of an alternative embodiment of dryer bump 80 shown in FIG. 3. A plurality of bumps 130 have a length 132 measured from a front end 134 to a back end 136, a height 138 measured from contact portion 90 to attachment portion 92, and a diameter 140. Bumps 130 extend substantially the entire length of drum 26 from front wall 62 to rear wall 66. Bumps 130 may be attached using one of the methods described above. Bumps 130 are shaped and sized similar to bumps 80. Bumps 130 are fabricated from a material similar to bumps 80.

The above-described clothes dryer is cost effective and energy efficient. The dryer includes a drum that includes a plurality of dryer bumps. Each bump is small and includes a contact portion that facilitates tumbling clothing articles, thus eliminating the need for baffles, and increasing the usable capacity of the dryer during dryer operations. As a result of the increased usable capacity, the operator may add additional laundry. Thus a dryer is provided which reduces the number of drying operations and conserves energy.

Exemplary embodiments of dryer drums and dryer bumps are described above in detail. The drums and bumps are not limited to the specific embodiments described herein, but rather, components of each may be utilized independently and separately from other components described herein. Each drum and bump component can also be used in combination with other dryer components.

While the invention has been described in terms of various specific embodiments, those skilled in the art will recognize that the invention can be practiced with modification within the spirit and scope of the claims.

1. A plurality of dryer bumps for a dryer drum, each said bump comprising:
a contact portion configured to be positioned within the drum proximate another bump contact portion, said contact portion having a height that is less than a width thereof;
an outer portion configured to be positioned adjacent to the drum; and
a body extending between said contact portion and said outer portion.

2. A plurality of dryer bumps in accordance with claim 1 wherein said contact portion is configured to secure at least one laundry article against said drum interior surface and allow substantially unobstructed access to said drum.

3. A plurality of dryer bumps in accordance with claim 1 wherein said outer portion is configured to secure said dryer bump to said drum.

4. A plurality of dryer bumps in accordance with claim 1 wherein said contact portion protrudes a distance into said drum and has a shape that may be selected from the group including a convex shape, a hemispherical shape, and a cylindrical shape.

5. A plurality of dryer bumps in accordance with claim 1 wherein said body extends through an aperture in said drum.

6. A plurality of dryer bumps in accordance with claim 15 wherein said dryer bump comprises an elastomer.

7. A plurality of dryer bumps in accordance with claim 1 wherein said dryer bump is unitary and solid.

8. A dryer drum for a clothes dryer comprising:
a perforated back wall;
a cylindrical outer wall adjacent to said back wall, said outer wall comprising:
an inner surface, an exterior surface, and a body extending therebetween; and
at least one dryer bump attached to said outer wall, wherein each said dryer bump comprises an elastomer.

9. A dryer drum in accordance with claim 8 wherein said outer wall body includes a plurality of circumferentially spaced apertures extending therethrough.

10. A dryer drum in accordance with claim 9 wherein each said body aperture is equally spaced and arranged in a plurality of rows, wherein each row is parallel to a horizontal axis of said drum and equally spaced circumferentially about said drum.

11. A dryer drum in accordance with claim 9 wherein each said outer wall aperture has a diameter that is configured to receive said at least one dryer bump, wherein each said dryer bump comprises a contact portion, an outer portion, and a body extending therethrough, said bump outer securing portion configured to be inserted through said aperture such that said bump body engages said aperture diameter.

12. A dryer drum in accordance with claim 8 wherein each said dryer bump contact portion extends inward a distance and is configured to secure at least one clothing article against said dryer drum outer wall.

13. A dryer drum in accordance with claim 8 wherein each said dryer contact portion has a shape that is one of a convex shape, a hemispherical shape, and a cylindrical shape.

14. (cancelled)

15. A clothes dryer comprising:
a cabinet;
a rotatable drum mounted in said cabinet, said drum configured to secure at least one laundry article against an inner surface of said drum during dryer operation, said drum further configured to allow substantially unobstructed access to said drum;
at least one dryer bump protruding in to said drum, said at least one dryer bump comprising a contact portion having a height and a width wherein said height is less than said width;
a motor for rotating said drum;
an air circulation system;
a heater for warming air circulated by said air circulation system;
a controller operatively coupled to said motor, said air circulation system temperature, and said heater.

16. A clothes dryer in accordance with claim 15 wherein said drum is rotatable about a horizontal axis and comprises a front wall, a back wall, and an outer wall extending therebetween, and at least one dryer bump, said at least one dryer bump positioned in said outer wall.

17. A clothes dryer in accordance with claim 15 wherein said drum outer wall is cylindrical and includes a plurality of apertures arranged in rows parallel to the horizontal axis of said drum.

18. A clothes dryer in accordance with claim 15 wherein each said drum aperture is configured to receive said at least one dryer bump.

19. A clothes dryer in accordance with claim 15 wherein each said dryer bump has a shape that is one of a convex shape, a hemispherical shape, and a cylindrical shape.

20. A clothes dryer in accordance with claim 15 wherein each said dryer bump comprises elastomer.
